(19) United States
(12) Patent Application Publication
(10) Pub. No.: US 2021/0186660 A1
(43) Pub. Date: Jun. 24, 2021

(54) DENTAL ALIGNER SEATING TOOL

(71) Applicant: Orthodontic Clinical Education Corporation, Toronto (CA)

(72) Inventor: Willy Z. DAYAN, Toronto (CA)

(73) Assignee: Orthodontic Clinical Education Corporation, Toronto (CA)

(21) Appl. No.: 16/719,223

(22) Filed: Dec. 18, 2019

(51) Int. Cl. A61C 7/02; A61C 7/08; A61C 7/14

(52) U.S. Cl. CPC A61C 7/02; A61C 7/146; A61C 7/08

(57) ABSTRACT

A tool for seating dental aligners is disclosed. The tool includes a longitudinally extending body that includes a handle positioned proximate a distal end of the body. A claw portion defined by a facial finger and a bite finger extends towards a proximal end of the body. The facial finger is adapted to transfer force applied using the handle portion to a facial surface of a dental aligner positioned along one of the upper teeth and the lower teeth of a user. The bite finger is adapted for compression between the mandible and maxilla of the user for applying force to an incisal-occlusal surface of the dental aligner. The bite finger and the facial finger are shaped and positioned relative to one another to allow concurrent application of force to the dental aligner for seating the dental aligner on the upper or the lower teeth of the user.

### FIELD

This relates to orthodontics and, more particularly, to an oral tool for seating dental aligners in the mouth.

### BACKGROUND

In the past, orthodontic appliances such as metal braces were used to align, straighten, and/or reposition the teeth of a patient. More recently, dental aligners have been introduced for similar purposes. Such aligners are sold, for example, under brand names such as Invisalign™ and ClearCorrect™. Dental aligners are trays formed of resilient plastic materials (e.g., using an elastic thermoplastic polyurethane resin) that are worn over a patient's upper and/or lower teeth. Dental aligners are formed so that they fit over the patient's teeth but are shaped so that contact between the aligner and the teeth, the resiliency of the plastic material, and the positioning of interior surfaces of the aligner relative to the teeth work together to exert forces on the teeth for repositioning them as the aligners are worn over time. By carefully designing a sequence of aligners to be worn by the patient over successive periods, an individual's teeth may be moved towards a desired orthodontic result.

In some cases, the aligner trays may be used together with other devices as a part of a treatment plan. For example, for some patients being treated with a dental aligner, a practitioner may install one or more “attachments” on their teeth. Attachments are small shapes that are attached to a patient's teeth such as, for example, using a dental composite. These attachments may act as a handle or ridge and may interact with the aligner to reposition teeth in the mouth. For example, a dental professional may install an attachment to allow an aligner to apply forces not possible without the attachment and/or stronger than may be otherwise applied. In a particular example, an attachment may be used to apply a force substantially perpendicular to a particular tooth to rotate the tooth in the mouth. Additionally or alternatively, attachments may be placed to allow an aligner to engage with a particular tooth to limit its movement such as, for example, where the aligner has been engineered to exert forces on adjacent teeth where, absent that attachment, those forces might also cause undesired movement of the particular tooth.

Patients wearing dental aligners must wear them in their mouths for long durations each day, but must also remove them to eat and drink. However, some patients being treated with dental aligners experience difficulty seating their aligners in their mouths over their teeth which can cause problems with treatment. For example, improperly seated aligners may hinder treatment of misaligned teeth; at the worst, an improperly seated aligner may cause teeth to move contrary to the treatment plan. In a particular example, if an aligner is not properly fitted over an attachment that was placed on a patient's tooth, the attachment may distort the resilient material of the aligner causing the dental aligner to exert force(s) on that tooth (and/or other teeth) in unintended manners. Repeated improper seating of aligners can lead to extended treatment or even a need for changes in the treatment plan to compensate for unintended movement of teeth due to the misplaced aligner not generating the intended forces on the wearer's teeth. Notably, if teeth are moved incorrectly due to a mis-seated aligner, it may even be that later aligners in a sequence will not fit over the patient's teeth due to the movement of the teeth not tracking according to the treatment plan as expected.

### BRIEF DESCRIPTION OF THE DRAWINGS

Embodiments are described in detail below, with reference to the following drawings:

FIG. 1 is a perspective view of an example dental aligner seating tool according to the present application showing the top of the tool;

FIG. 2 is a perspective view of the dental aligner seating tool of FIG. 1 showing the bottom thereof;

FIG. 3 is top plan view of the dental aligner seating tool of FIG. 1;

FIG. 4 is a bottom plan view showing the dental aligner seating tool of FIG. 1;

FIG. 5 is a side elevation view of the dental aligner seating tool of FIG. 1;

FIG. 6 is an elevation view of a handle end of the dental aligner seating tool of FIG. 1;

FIG. 7 is an elevation view of a claw end of the dental aligner seating tool of FIG. 1;

FIGS. 8A and 8B illustrate the use of the dental aligner seating tool of FIG. 1 to seat a dental aligner on the upper teeth of a user;

FIGS. 9A and 9B show how the dental aligner seating tool of FIG. 1 may be employed in seating a dental aligner over an attachment on the upper teeth of a user;

FIG. 10 is a side cross-sectional view of the dental aligner seating tool of FIG. 1 taken along the line 10-10 of FIG. 3;

FIG. 11 is a top cross-sectional view of the dental aligner seating tool of FIG. 1 taken along the line 11-11 of FIG. 5; and

FIG. 12 is a side elevation view of an example dental aligner seating tool.

Like reference numerals are used in the drawings to denote like elements and features.

### DETAILED DESCRIPTION OF EXAMPLE EMBODIMENTS

Patients may experience difficulty in seating aligners for a variety of reasons. For example, some may simply not like to put their fingers or hands in their mouth. Additionally or alternatively, some or all of the aligners in a sequence of aligners corresponding to a particular treatment plan may be difficult to fit over a patient's teeth, especially during the initial wearing period for a given aligner. This difficulty may stem from a variety of factors: for example, difficulty in seating a given aligner could stem from the need to fit it over the geometry of the teeth. Indeed, it may not be possible to seat a given aligner simply by pushing it upwards onto the upper teeth or downwards on the lower teeth. For example, an aligner may need to be distorted to fit over a convex portion of the tooth. Relatedly, some force and/or manipulation may be necessary to urge an aligner over one or more attachments mounted on the teeth and to engage those attachments with corresponding undercuts in the aligner. For example, in order to seat an aligner in these and/or other circumstances, a user may need to urge the aligner over the teeth vertically in a direction parallel to the front of the set of teeth (upper/maxillary or lower/mandibular) over which it is being seated while also urging or massaging the aligner so that forces are also exerted on the outer surface of the aligner at least partially perpendicular to the face of the teeth. In effect, to properly seat a dental aligner on a wearer's teeth, the aligner may need to be manipulated in a manner similar to obtaining a displacement fit of other resilient plastic objects with rigid/semi-rigid objects such as, for example, when the edge of a plastic coffee lid is fit down and over the lip of a paper coffee cup.

According to the subject matter of the present application, there may be provided a tool for seating dental aligners. The tool may include a longitudinally extending body. The longitudinal extending body may include a handle portion positioned proximate a distal end of the body. The tool may include a claw portion. The claw portion may be defined by a facial finger and a bite finger. The claw portion may extend towards a proximal end of the body. The facial finger may be adapted to transfer force applied using the handle portion to a facial surface of a dental aligner positioned along one of the upper teeth and/or the lower teeth of a user. The bite finger may be adapted for compression between the mandible and maxilla of the user for applying force to an incisal-occlusal surface of the dental aligner. It may be that the bite finger and the facial finger are shaped and positioned relative to one another to allow concurrent application of force to the dental aligner using the bite finger and the facial finger for seating the dental aligner on the one of the upper and/or lower teeth of the user.

Conveniently, such a tool may allow an aligner to be seated on a user's teeth more easily than via other methods. Additionally or alternatively, use of a tool according to the present application may allow a user to seat a dental aligner over their teeth while avoiding the need to reach into their mouth with their hands.

In some implementations, it may be that the bite finger and the facial finger are shaped and positioned relative to one another to allow use of the facial finger to apply force to a gingival portion of the facial surface of the dental aligner concurrent with application of force to the incisal-occlusal surface of the dental aligner using the bite finger for seating the dental aligner on the one of the upper and/or lower teeth of the user.

In some implementations, it may be that the bite finger and the facial finger are shaped and positioned relative to one another to allow the tool to be pivoted relative to the incisal-occlusal surface of the dental aligner as force is applied thereto through compression of the bite finger between the mandible and maxilla of the user. Such pivoting may allow force to be selectively applied to the facial surface of the dental aligner using the facial finger concurrent with the application of force to the incisal-occlusal surface of the dental aligner.

In some implementations, the bite finger may extend proximally beyond a tip of the facial finger. For example, it may be that the bite finger extends proximally beyond the tip of the facial finger by between about 6 mm and 10 mm. Additionally or alternatively, it may be that the distance between the tip of the facial finger and a nearest point on the bite finger to the tip of the facial finger is between about 3 mm and 7 mm.

In some implementations, the distance between the tip of the facial finger and the tip of the bite finger may be between about 8 mm and 12 mm.

In some implementations, the handle portion may extend distally by at least 30 mm.

In some implementations, the claw portion may be substantially c-shaped, u-shaped, j-shaped, or v-shaped.

In some implementations, the handle portion may have a handling surface formed of a rubberized material.

According to the subject matter of the present application, there may be provided a method of seating a dental aligner. The method may include providing a tool as described herein, compressing the bite finger of the tool between the mandible and maxilla of the user to apply force to the incisal-occlusal surface of the dental aligner; and, while the bite finger is being compressed, applying force to the facial surface of the dental aligner by using the handle portion of the tool to urge the facial finger towards the facial surface of the dental aligner.

In some cases, the facial finger may apply force to a gingival portion of the facial surface of the dental aligner.

In some cases, the bite finger and the facial finger are shaped and positioned relative to one another to allow the tool to be pivoted relative to the incisal-occlusal surface of the dental aligner as force is applied thereto, and it may be that applying the force to the facial finger using the handle portion includes pivoting the tool relative to the incisal-occlusal surface of the dental aligner.

According to the subject matter of the present application, there may be provided a tool for seating dental aligners. The tool may include a handle portion and a claw portion. The claw portion may include a facial finger and a bite finger. The bite finger may extend away from the handle portion and beyond a tip of the facial finger.

In some implementations, the claw portion may be substantially c-shaped, u-shaped, j-shaped, or v-shaped.

In some implementations, the bite finger may extend beyond the tip of the facial finger by between about 6 mm and 10 mm.

In some implementations, the distance between the tip of the facial finger and a nearest point on the bite finger to the tip of the facial finger may be between about 3 mm and 7 mm.

In some implementations, the distance between the tip of the facial finger and a tip of the bite finger may be between about 8 mm and 12 mm.

In some implementations, the handle portion may include a rubberized handling surface.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

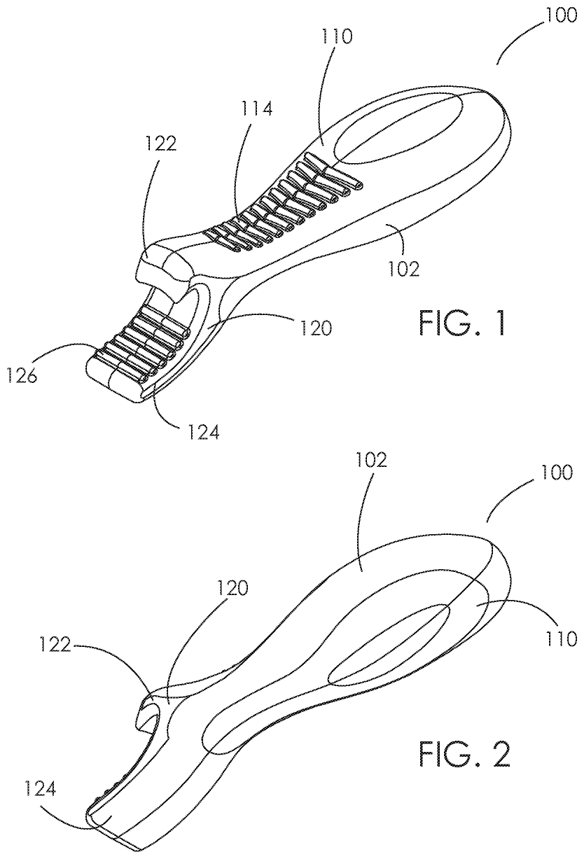

A dental aligner seating tool 100 according to the present application is shown in various views in FIGS. 1-7.

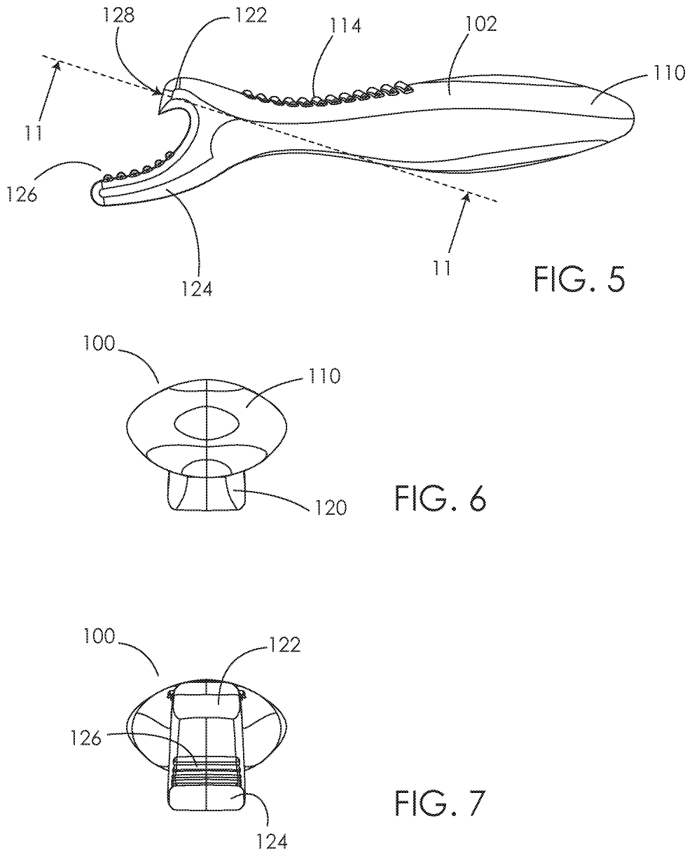

As perhaps best shown in FIGS. 1 and 5, the dental aligner seating tool 100 has a longitudinally extending body 102. The body 102 includes at least two portions: a handle portion 110 and a claw portion 120. The handle portion 110 is positioned proximate a first end of the body 102. The claw portion 120 is positioned proximate a second, opposite end of the body 102. As such, it may be said that the longitudinally extending body 102 includes the handle portion 110 positioned proximate a distal end of the body 102 and that the claw portion 120 is positioned proximate a proximal end of the body 102.

As perhaps best shown in FIG. 5, the claw portion 120 is defined by two fingers, a facial finger 122 and a bite finger 124, each of which extends towards the aforementioned proximal end of the body 102. The bite finger 124 may, as shown, extend away from the handle portion 110. For example, the bite finger 124 may extend beyond a tip 128 of the facial finger 122. The tip 128 of the facial finger 122 may, as shown, be substantially convex. The facial finger 122 and the bite finger 124 may, as shown, define a substantially c-shaped claw portion 120. Conveniently, as further described below, such a c-shape may allow the claw portion 120 to be used to seat dental aligners over teeth and/or in mouths of various sizes and shapes. Alternatively, in some embodiments, the facial finger 122 and the bite finger 124 may define a claw portion 120 having another shape. For example, the overall shape of the claw portion 120 may vary depending upon how far each of the facial finger 122 and the bite finger 124 projects proximally both in absolutely terms and relative to one another in a given embodiment as well as the overall direction in which each projects and whether each finger is straight, curved or otherwise shaped. For example, in some embodiments, it may be that the claw portion 120 is substantially u-shaped, j-shaped, or v-shaped. It may be that different claw portions having different shapes are better suited to fitting aligners formed of different materials and/or having different geometric characteristics.

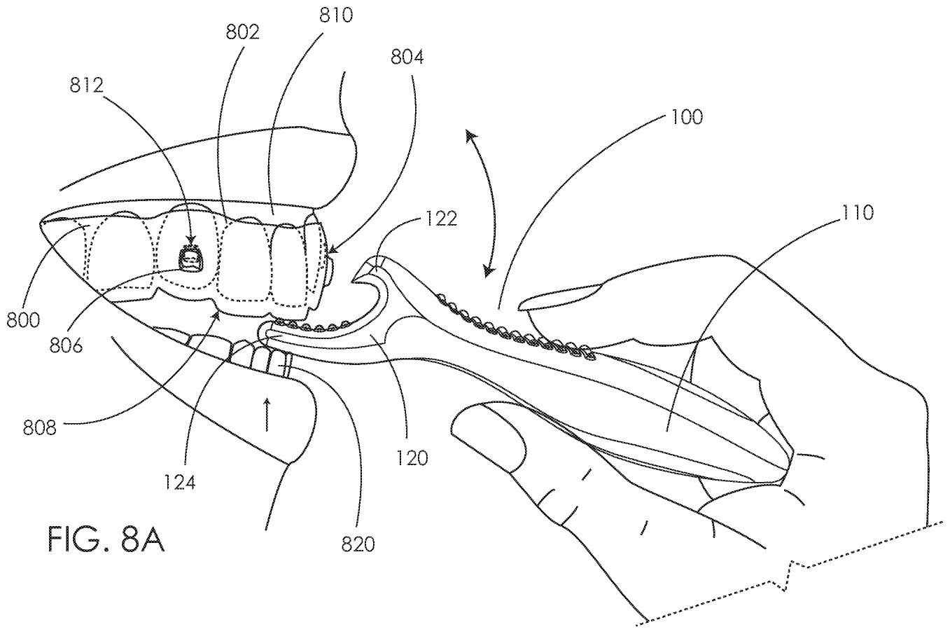

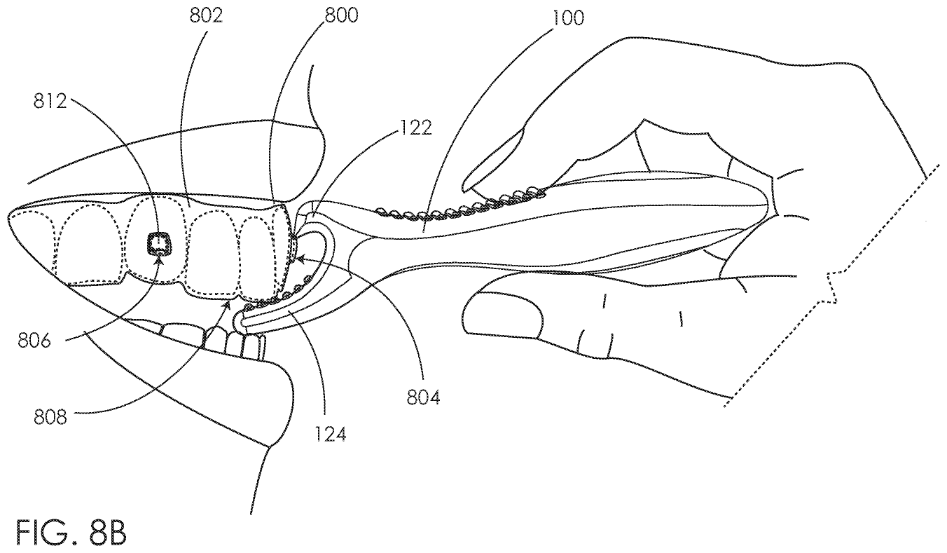

An example of the use of the dental aligner seating tool 100 will now be described with reference to FIGS. 8A and 8B. FIGS. 8A and 8B perspective views illustrating a time sequence in which the dental aligner seating tool 100 is being used to seat a dental aligner 800 on the upper teeth 810 of a user.

Referring to FIG. 8A, the dental aligner 800 has been placed over the teeth of a patient/user. In particular, the dental aligner 800 is an upper aligner and has been placed over the upper teeth 810 of the user. Notably, the dental aligner 800 is not yet correctly seated on the upper teeth 810. For example, as illustrated, the contoured upper edge of the gingival portion 802 of the facial surface 804 of the dental aligner 800 is not yet aligned with the upper edge of the upper teeth 810. Further, an attachment 812 (shown in stippled lines) affixed to one of the upper teeth 810 is not yet engaged or aligned in a corresponding cutaway 806 in the dental aligner 800.

In order to seat the dental aligner 800 on the upper teeth 810, the dental aligner 800 needs to be moved upwards on the upper teeth 810. This may require the dental aligner 800 to be manipulated to both urge it upwards towards the gumline but also to allow it to pass over the geometry of the upper teeth 810 including the displacing of the facial surface 804 (the outer surface of the aligner that is visible when it is worn) as needed to allow the attachment 812 to be received in the cutaway 806.

Such a displacement fit of the dental aligner 800 over the upper teeth 810 may be achieved by applying force to the dental aligner 800 using the dental aligner seating tool 100. More particularly, the dental aligner seating tool 100 may be used to apply forces both substantially vertical and substantially laterally to the dental aligner 800. Such forces may be applied to the dental aligner 800 by the claw portion 120 and, more particularly, by respective ones of the facial finger 122 and the bite finger 124. Further by moving the dental aligner seating tool 100 along the teeth, such forces may be applied to different portions of the dental aligner 800 in order to seat it on the upper teeth 810 in manners further described below.

In order to apply forces to the dental aligner 800 in order to seat it on the upper teeth 810, the user may use the handle portion 110 to manipulate the dental aligner seating tool 100. For example, as illustrated, the user may pivot the dental aligner seating tool 100 in the mouth (compare FIGS. 8A and 8B) relative to the bite finger 124 using the handle portion 110. The force applied by manipulation of the handle portion 110 may then be transferred to the facial surface 804 of the dental aligner 800 through contact with the facial finger 122. Put another way, the facial finger 122 is adapted to transfer force applied to the dental aligner seating tool 100 using the handle portion 110 to the facial surface 804 of the dental aligner 800. The facial finger 122 may apply force to different portions of the facial surface 804 depending on the overall shape of the dental aligner seating tool 100 including for example the shape of the facial finger 122. For example, as shown in FIG. 8B, the facial finger 122 may apply force to the gingival portion 802 of the facial surface 804 of the dental aligner 800.

The dental aligner seating tool 100 may also be used to apply substantially vertical forces to the dental aligner 800 by way of the bite finger 124. In particular, the user may, as shown, bite down on the bite finger 124. In this way, the bite finger 124 may direct the force arising from the drawing together of the upper teeth 810 and the lower teeth 820 (i.e., the drawing together of the mandible and maxilla) and the compression of the bite finger 124 therebetween to an incisal-occlusal surface 808 of the dental aligner 800 (e.g., the bottom edge of the dental aligner 800 or the top edge of if the aligner were a bottom teeth aligner). Put another way, the bite finger 124 is adapted for compression between the mandible and maxilla of the user so as to apply force to the incisal-occlusal surface 808 of the dental aligner 800.

Notably, the C-shape of the claw portion 120 of the dental aligner seating tool 100 and the length of the bite finger 124 may allow the dental aligner seating tool 100 to be positioned in mouths and/or about teeth of a range of different sizes while still allowing the facial finger 122 to strike a given dental aligner at a desired position despite differences in teeth, mouth, and/or aligner dimensions.

In summary, in order to seat the dental aligner 800 on the upper teeth 810, a user may manipulate the handle portion 110 and then the claw portion 120 and, more particularly, the facial finger 122 may then transfer the force applied to the handle portion 110 to the facial surface 804 of the dental aligner 800. Concurrently, the user may compress the bite finger 124 between their mandible and maxilla to apply force to the incisal-occlusal surface 808 of the dental aligner. In this way, a displacement fit of the dental aligner 800 over the upper teeth 810 required for proper seating may be achieved. Conveniently, it may be that the dental aligner seating tool 100 allows such seating to be achieved without the need to insert the user's fingers or hands into the mouth to manipulate the aligner directly. In summary, seating of the dental aligner 800 may be eased. Notably, increased ease of insertion/reinsertion of and, more particularly, seating of the dental aligner 800 may increase adherence to treatment requirements including the above-discussed required wear time. Furthermore, because patients are generally expected to remove dental aligners in order to eat or to drink anything other than cool water, eased reinsertion of the aligner may increase user acceptance and/or reduce dissatisfaction with wearing of the aligner and/or may improve treatment adherence such as, for example, in relation to the removal of aligners during food/drink consumption.

Notably, as mentioned above, in at least some embodiments, the dental aligner seating tool 100 may allow substantially vertical and substantially lateral forces to be applied concurrently or in alternation. For example, it may be that the dental aligner seating tool 100 is formed to allow manipulation that will apply such forces selectively such as, for example, in alternation. Such forces could, for example, be applied selectively in the illustrated example by pivoting the dental aligner seating tool 100 to apply force using the facial finger 122 as needed and by varying the pressure with which the user bites down on the bite finger 124. Notably, in such a scenario it is the pivoting that allows the application of force to the facial surface 804 to be done selectively. Such forces may, as mentioned, also be applied concurrently. More particularly, in at least some tools according to the present application, the two fingers of the claw portion 120 may be shaped, sized, and/or positioned relative to one another so as to allow both the facial finger 122 and the bite finger 124 to be used to exert force on the dental aligner 800 at the same time. For example, the bite finger 124 and the facial finger 122 may be shaped and positioned relative to one another to allow use of the facial finger 122 to apply force to the facial surface 804 of the dental aligner 800 (e.g., to the gingival portion 802) as the handle portion 110 is pivoted concurrent with application of force to the incisal-occlusal surface 808 of the dental aligner 800 using the bite finger 124 (i.e., as the bite finger 124 is being compressed between the jaws) for seating the dental aligner 800 on the upper teeth 810 of the user as shown in FIG. 8B. In particular, the bite finger 124 and the facial finger 122 may, as shown, be shaped and positioned relative to one another to allow the dental aligner seating tool 100 to be pivoted relative to the incisal-occlusal surface 808 of the dental aligner 800 concurrent with the application of force to the incisal-occlusal surface 808 of the dental aligner 800 using the bite finger 124 as depicted in FIGS. 8A and 8B. Conveniently, applying such forces to the dental aligner 800 concurrently may allow it to be more easily urged over portions of the upper teeth 810 as compared to if force is only applied to one of the surfaces and/or such forces are applied in alternation.

The dental aligner seating tool 100 may allow a dental aligner to be more easily positioned over one or more attachments. For example, concurrent application of forces to the incisal-occlusal surface 808 and the facial surface 804 in areas of the dental aligner 800 proximate to the cutaway 806 may allow a user to more easily align the attachment 812 in the cutaway 806 as compared to if such forces were applied separately and/or to different regions of the aligner. This may, for example, be because unintended rotational forces on the aligner may be avoided and/or, because the coffee-cup type “up and over” displacement fit mentioned above may be more easily effected.

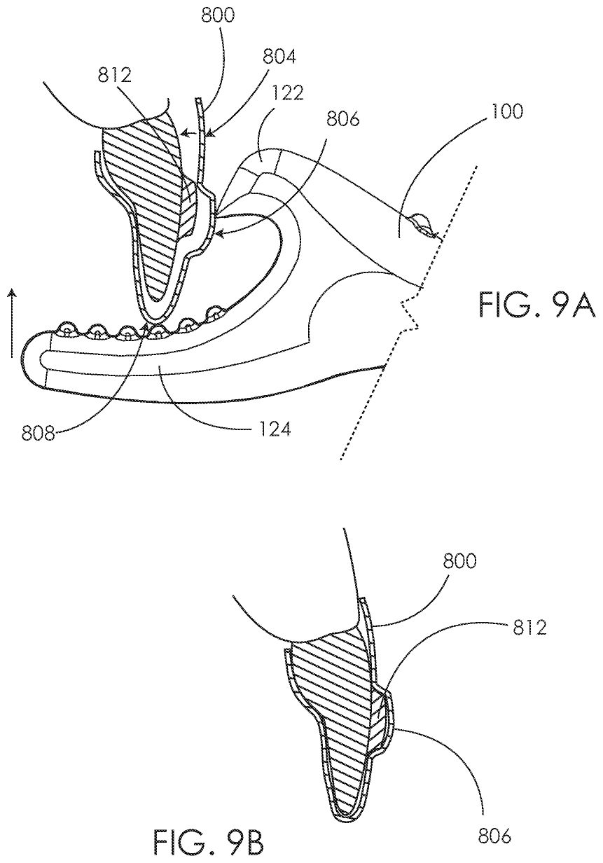

The use of the dental aligner seating tool 100 in aligning the attachment 812 in the cutaway 806 is illustrated in FIG. 9A. As illustrated, the dental aligner seating tool 100 may be used both to apply force currently to both the incisal-occlusal surface 808 (by way of the bite finger 124) and the facial surface 804 (by way of the facial finger 122) of the dental aligner 800. In this way, a user of the dental aligner seating tool 100 may distort and/or urge the dental aligner 800 so as to displace the cutaway 806 up and over the attachment 812, thereby seating the dental aligner 800 in a proper position with the attachment 812 positioned in the cutaway 806 as shown in FIG. 9B.

Referring again to FIGS. 8A and 8B, it is noted that a user may change the particular portion(s) of the facial surface 804 and/or of the incisal-occlusal surface 808 to which force is applied by repositioning the dental aligner seating tool 100 in the mouth relative to the dental aligner 800. For example, by repositioning the dental aligner seating tool 100 the bite finger 124 may be made to fall between different portions of the upper and lower jaws and thus push or hammer on a different portion of the incisal-occlusal surface 808. Correspondingly, such repositioning may also allow the facial finger 122 to be made to push or hammer on a different portion of the facial surface 804.

By successively and/or selectively manipulating the dental aligner 800 using the dental aligner seating tool 100, a user may use the dental aligner seating tool 100 to seat the dental aligner 800 on the upper teeth 810.

Notably, although the above example relates to use of the dental aligner seating tool 100 to seat the dental aligner 800 on the upper teeth 810, the dental aligner seating tool 100 could be equally used to seat a suitable dental aligner on the lower teeth 820 by flipping (rotating 180 degrees) the dental aligner seating tool 100 so that the facial finger 122 can act on the facial surface of a lower teeth dental aligner when it is placed over the lower teeth 820.

The various potential benefits such as may be achieved in using the dental aligner seating tool 100 to seat a dental aligner may not be achieved if a user uses other oral tools to try to seat a dental aligner. For example, a commercially-available product known as a “chewies” is marketed for the use in seating dental aligners in mouths. Chewies are small cylindrical pieces of a rubbery material. Users are encouraged to place their aligner over their teeth and then bite down or chew on a chewie while manipulating their aligner in an effort to seat the aligner properly over the teeth. However, chewies do not allow force to be applied to a facial surface of a dental aligner, so users of chewies may still need to reach into their mouths to achieve proper seating of aligners. Notably, however, using the fingers to press on an aligner while biting down on a chewy may make seating of a dental aligner more difficult than if the dental aligner seating tool 100 is applied. For example, a user may find it more difficult to apply force to the facial surface of the aligner due to the need to press directly on it rather than pivoting the handle portion 110 if the dental aligner seating tool 100 is employed. Notably, for example, difficulty may be encountered when using a device such as chewy when applying force to a facial surface of the aligner as it can be necessary to press on the facial surface near the gingiva. Due to the size of the finger and/or the sensitivity of the gingiva, force applied to the facial surface of an aligner at or about the gingiva may be particularly noticeable or even painful to a user leading the user to back-off or otherwise apply insufficient pressure. Such insufficient application force can lead to an inability to seat the aligner and/or improper seating thereof. Further, because, for example, of the size of their fingers, some users may generally find it difficult to press on the facial surface of the aligner in an area of the aligner proximate the area of incisal-occlusal surface where the chewie is being bit (e.g., due to space concerns). For example, the user may thus choose to apply force to the facial surface in a different area of the mouth. Notably, this may mean it could be more difficult to achieve a displacement fit of the aligner in the mouth through use of a chewie and a user's fingers as compared to if the dental aligner seating tool 100 were employed due to the disparate areas of the aligner in which the substantially vertical and the substantially lateral forces are being applied in the case of using chewie as compared to a coordinated application of forces such as may be possible when the dental aligner seating tool 100 is employed.

Another commercially-available product is known as a Clenchy™. Clenchy is an elongated piece of flexible material having both a flat and an undulating portion. Clenchy is used in a similar manner as a chewie and thus suffers from similar deficiencies. For example, like a chewie, Clenchy only operates to apply force to the incisal-occlusal surface of an aligner and, also like the chewie, relies on a user using their fingers to apply concurrently apply force to a facial surface of a given aligner in a co-ordinated manner in order to seat that aligner over the user's teeth.

In some embodiments, the dental aligner seating tool may be textured in one or more areas. For example, a textured handling surface 114 may be provided as shown, for example, in FIGS. 1 and 5. Conveniently, such a textured surface may assist in manipulation of the handle portion 110 when the dental aligner seating tool 100 is employed such as, for example, in manners discussed above, Additionally or alternatively, for comfort in so manipulating the handle portion 110, some or all of the handle portion 110 may include a rubberized handling surface. For example, in some embodiments, all or a portion of the textured handling surface 114 may be rubberized.

As another example of possible texturing, the dental aligner may include a textured bearing surface 126 as shown, for example, in FIG. 1. Conveniently, such a textured bearing surface may allow a user to more easily obtain and maintain engagement between the bite finger 124 and a dental aligner being manipulated using the dental aligner seating tool 100 when biting down on the bite finger 124. In some embodiments, all or a portion of the textured bearing surface 126 may be rubberized. Conveniently, such rubberization may protect the teeth and/or aligner(s) during biting.

The dental aligner seating tool 100 may be formed of a variety of materials and in a variety of fashions. For example, the dental aligner seating tool 100 may be formed from one or more materials suitable for use in the mouth such as, for example, by way of molding and/or machining.

In one example of materials that may be used to form the dental aligner seating tool 100, the dental aligner seating tool 100 may be formed of one or more suitable plastics (e.g., by molding). For example, it may be that some or all the dental aligner seating tool 100 is formed of a harder plastic such as, for example, polypropylene (PP). Additionally or alternatively, some or all of the dental aligner seating tool 100 may be formed of a softer plastic such as, for example, a thermoplastic elastomer (TPE) such as, for example, thermoplastic polyurethane (TPU).

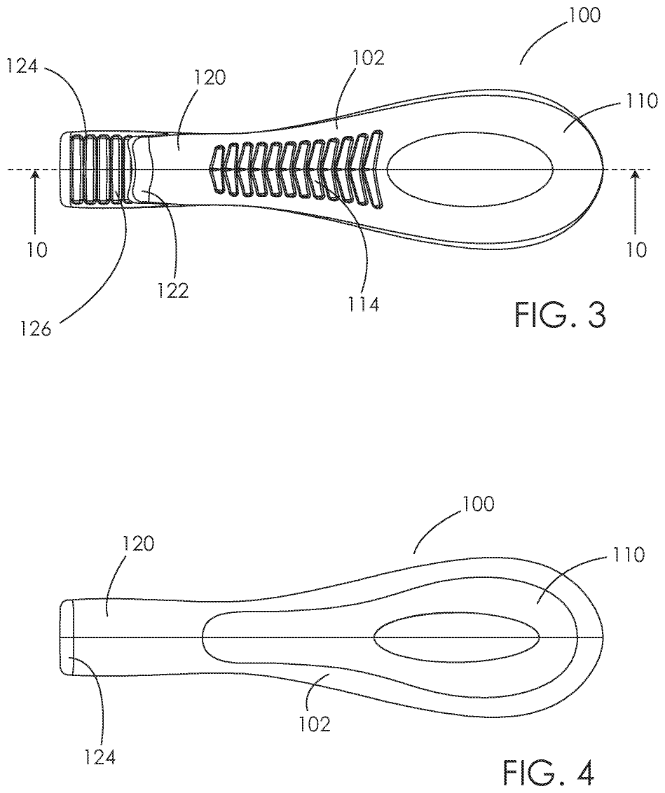

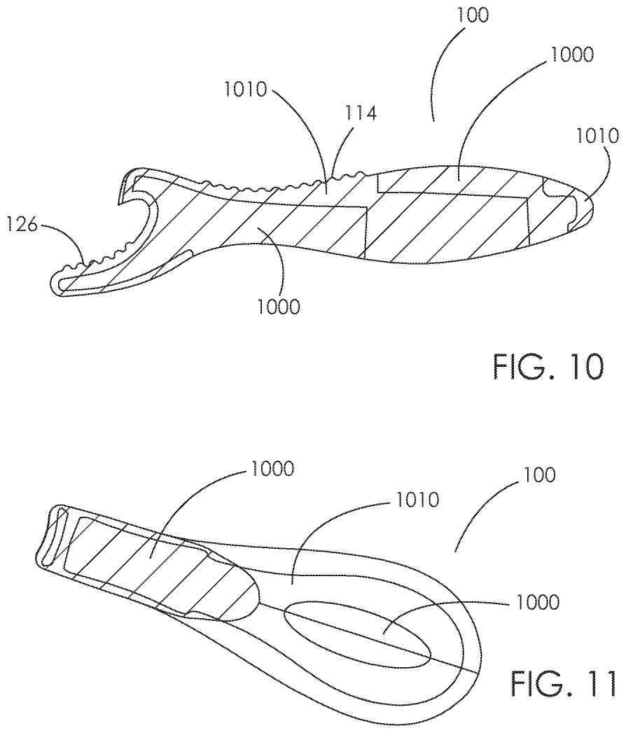

In some embodiments, the dental aligner seating tool 100 may be formed of more than one plastic such as, for example, by way of using plastic over-molding techniques. For example, it may be that a portion of the dental aligner seating tool 100 is first molded using a harder plastic such as, for example, PP. Then, that portion of the dental aligner seating tool 100 may be over-molded using a softer plastic such as, for example, TPE. A particular example of such a two-part embodiment of the dental aligner seating tool 100 such as may be formed using over-molding is shown in FIGS. 9 and 10. FIG. 10 provides a side elevation cross-section of the dental aligner seating tool 100 taken along a line 10-10 of FIG. 3. FIG. 11 provides another cross-section of the dental aligner seating tool 100 taken along a line 11-11 of FIG. 5. As shown in FIGS. 10 and 11, the dental aligner seating tool 100 may have two portions: a first portion 1000 and a second portion 1010. The first portion 1000 acts as a frame for the dental aligner seating tool 100 and may be formed of a harder plastic (e.g., PP). The second portion 1010 may be formed of a more flexible/rubbery plastic (e.g., TPE). The second portion 1010 defines portions of the surface of dental aligner seating tool 100 providing surfaces such as, for example, the textured handling surface 114 and the textured bearing surface 126. Notably, where the second portion 1010 is formed of a rubbery plastic such as TPE, the textured handling surface 114 and the textured bearing surface 126 may be considered rubberized. The second portion also extends through the body 102 of the dental aligner seating tool 100 as shown, for example, in FIG. 11. Conveniently, by using a softer and/or more flexible material in the interior of the body 102, the dental aligner seating tool 100 may have more “give” (e.g., may flex slightly during use). A dental aligner seating tool 100 having more give may be more durable during prolonged use (e.g., more robust and/or less prone to breaking). Notably, however, it may be necessary to form a least a portion of the dental aligner seating tool 100 out of a more rigid material. For example, if the dental aligner seating tool 100 is formed entirely of a rubberized material, the dental aligner seating tool 100 may flex too much during use and, in particular, may thereby hinder application of sufficient force to a dental aligner using the dental aligner seating tool 100. It may be that these two considerations are balanced through the forming of the dental aligner seating tool 100 out of a combination of rubberized and more rigid materials such as was discussed above.

As mentioned above, dental aligner seating tools according to the present application may be of a variety of shapes and also sizes. For example, the handle portion 110 could be repositioned relative to the claw portion 120 and/or the handle portion 110 could have a different shape so as to change the degree of offset therebetween. Notably, such variation may produce dental aligner seating tools that are more comfortable/more suited for use seating aligners over one of the upper or the lower teeth and/or may allow a design to be produced that is reasonably-well suited to both use cases. Furthermore, the dimensions of the bite finger 124 and the facial finger 122 may be varied in terms of length, thickness, and/or width to better suit different sizes of mouths. Additionally or alternatively, differently sized and/or shaped fingers may be better suited for seating of aligners formed of different plastics and/or for seating aligners over teeth having more or fewer attachments.

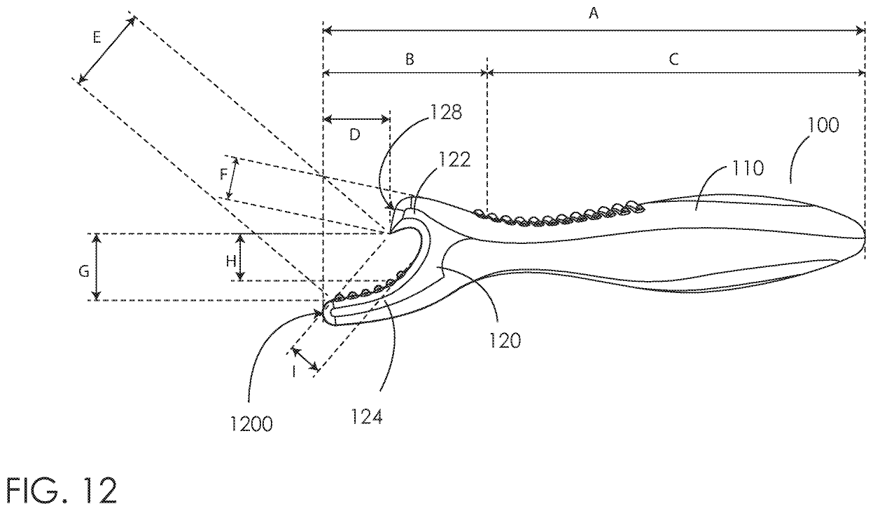

An example of sizes for different portions of the dental aligner seating tool 100 in an example embodiment will now be discussed with reference to FIG. 12.

In the following discussion, reference is made to particular distances and ranges of distances such as may correspond to the embodiment illustrated in FIG. 12. In at least some cases, reference is made to a distance being of “about” some value. In this usage, the term “about” refers to a value in the range of the specified value within a suitable range or tolerance depending on the nature and circumstances of what is being measured, the materials and manufacturing techniques employed, etc. Similarly, references to a distance being between “about” a lower bound and an upper bound maybe understood as the value being within that range plus or minus a suitable tolerance depending on the nature and circumstances. In each case (about a value and/or about an endpoint of a range), in at least some circumstances, a suitable tolerance may be ±10%.

Referring to FIG. 12, the length of the dental aligner seating tool 100 (distance A) may be between about 60 mm and 70 mm. For example, the distance A may be about 65 mm.

The length of the claw portion 120 (distance B) may be between about 15 mm and 25 mm. For example, the claw portion 120 may extend longitudinally by about 20 mm.

The handle portion 110 may extend distally by at least 30 mm. A handle portion 110 having such a length may allow for adult hands to more easily manipulate the dental aligner seating tool 100. For example, the length of the handle portion 110 (distance C) may be between about 40 mm and 50 mm. In a particular example, the handle portion 110 may extend longitudinally by 45 mm to provide a handle of a reasonably substantial length without being unwieldy.

As mentioned above, the bite finger 124 may extend proximally beyond the tip 128 of the facial finger 122. Notably, as mentioned above, a longer bite finger 124 may allow the dental aligner seating tool 100 to be used with mouths, teeth, and/or dental aligners of more varied sizes while still allowing the facial finger 122 to be positioned to act on a desired portion of the facial surface of a dental aligner (e.g., a portion proximate the gingiva/gums). As an example, the bite finger 124 may extend proximally beyond the tip 128 of the facial finger 122 (distance D) by between about 6 mm and 10 mm to allow the dental aligner seating tool 100 to be used with a range of mouth sizes. In a particular example, the distance D may be about 8 mm.

The spacing between the bite finger 124 and the facial finger 122 may also affect the range of sizes of mouths, teeth, and/or aligners with which a given dental aligner seating tool may be used. For example, an embodiment of the dental aligner seating tool 100 in which the straight-line distance between the tip 128 of the facial finger 122 and a tip 1200 of the bite finger 124 (distance E) is between about 8 mm and 12 mm may potentially be used with a range of common mouth sizes. In a particular example, the distance E could be about 10 mm. As another example of spacing between the bite finger 124 and the facial finger 122, the distance between the tip 128 of the facial finger 122 and a nearest point on the bite finger 124 to the tip 128 (distance H) may be between about 3 mm and 7 mm to accommodate average anatomy. For example, the distance H may be about 5 mm. Further, because the bite finger 124 is curved, the distance between the tip 128 and the tip 1200 measured parallel to the distance H may be longer. This distance—distance G—may be between about 6 mm and 10 mm. For example, the distance G may be about 8 mm.

As mentioned above, the sizes of the facial finger 122 and the bite finger 124 may also vary. In a particular example, the height of the tip 128 (distance F) may vary. For example, it may be that the distance F is between about 3 mm and 7 mm to allow use of the tool with aligners of different sizes while also providing a surface of sufficient size to avoid a too much of point loading of the facial surface of the aligner being seated as this could undesirably distort the aligner. In a particular example, the distance F may be about 5 mm.

Of course, the above distances may, as mentioned above, be varied depending on the size, shape, and scale of a given embodiment. For example, it may be that larger or smaller dental aligner seating tools have distances selected by scaling the distances given above up or down by a suitable multiplicative factor.

As noted, certain adaptations and modifications of the described embodiments can be made. Therefore, the above discussed embodiments are considered to be illustrative and not restrictive.

What is claimed is:

1. A tool for seating dental aligners, the tool comprising:
a longitudinally extending body including a handle portion positioned proximate a distal end of the body; and
a claw portion defined by a facial finger and a bite finger extending towards a proximal end of the body, the facial finger adapted to transfer force applied using the handle portion to a facial surface of a dental aligner positioned along one of the upper teeth and the lower teeth of a user, and the bite finger adapted for compression between the mandible and maxilla of the user for applying force to an incisal-occlusal surface of the dental aligner,
wherein the bite finger and the facial finger are shaped and positioned relative to one another to allow concurrent application of force to the dental aligner using the bite finger and the facial finger for seating the dental aligner on the one of the upper and lower teeth of the user.

2. The tool of claim 1, wherein the bite finger and the facial finger are shaped and positioned relative to one another to allow use of the facial finger to apply force to a gingival portion of the facial surface of the dental aligner concurrent with application of force to the incisal-occlusal surface of the dental aligner using the bite finger for seating the dental aligner on the one of the upper and lower teeth of the user.

3. The tool of claim 1, wherein the bite finger and the facial finger are shaped and positioned relative to one another to allow the tool to be pivoted relative to the incisal-occlusal surface of the dental aligner as force is applied thereto through compression of the bite finger between the mandible and maxilla of the user, the pivoting allowing force to be selectively applied to the facial surface of the dental aligner using the facial finger current with the application of force to the incisal-occlusal surface of the dental aligner.

4. The tool of claim 1, wherein the bite finger extends proximally beyond a tip of the facial finger.

5. The tool of claim 4, wherein the bite finger extends proximally beyond the tip of the facial finger by between about 6 mm and 10 mm.

6. The tool of claim 4, wherein a distance between the tip of the facial finger and a nearest point on the bite finger to the tip of the facial finger is between about 3 mm and 7 mm.

7. The tool of claim 1, wherein a distance between a tip of the facial finger and a tip of the bite finger is between about 8 mm and 12 mm.

8. The tool of claim 1, wherein the handle portion extends distally by at least 30 mm.

9. The tool of claim 1, wherein the claw portion is substantially c-shaped, u-shaped, j-shaped, or v-shaped.

10. The tool of claim 1, wherein the handle portion has a handling surface formed of a rubberized material.

11. A method of seating a dental aligner, the method comprising:
providing a tool according to claim 1;
compressing the bite finger of the tool between the mandible and maxilla of the user to apply force to the incisal-occlusal surface of the dental aligner; and
while the bite finger is being compressed, applying force to the facial surface of the dental aligner by using the handle portion of the tool to urge the facial finger towards the facial surface of the dental aligner.

12. The method of claim 11 wherein the facial finger applies force to a gingival portion of the facial surface of the dental aligner.

13. The method of claim 11, wherein the bite finger and the facial finger are shaped and positioned relative to one another to allow the tool to be pivoted relative to the incisal-occlusal surface of the dental aligner as force is applied thereto, and wherein applying the force to the facial finger using the handle portion includes pivoting the tool relative to the incisal-occlusal surface of the dental aligner.

14. A tool for seating dental aligners, the tool comprising:
a handle portion; and
a claw portion including a facial finger and a bite finger, the bite finger extending away from the handle portion and beyond a tip of the facial finger.

15. The tool of claim 14, wherein the claw portion is substantially c-shaped, u-shaped, j-shaped, or v-shaped.

16. The tool of claim 14, wherein the bite finger extends beyond the tip of the facial finger by between about 6 mm and 10 mm.

17. The tool of claim 14, wherein a distance between the tip of the facial finger and a nearest point on the bite finger to the tip of the facial finger is between about 3 mm and 7 mm.

18. The tool of claim 14, wherein a distance between the tip of the facial finger and a tip of the bite finger is between about 8 mm and 12 mm.

19. The tool of claim 14, wherein the handle portion includes a rubberized handling surface.
